(19) United States
(12) Patent Application Publication
(10) Pub. No.: US 2005/0218156 A1
(43) Pub. Date: Oct. 6, 2005

(54) Dog poop destroyer

(76) Inventor: Scott Goldberg, San Ramon, CA (US)

Correspondence Address: BRUCE & MCCOY, ONE KAISER PLAZA, STE. 750, OAKLAND, CA, 94612, US

(21) Appl. No.: 10/819,767

(22) Filed: Apr. 6, 2004

(51) Int. Cl. B65G 47/34

(52) U.S. Cl. 222/145.5; 222/630; 239/154

(57) ABSTRACT

A dog poop destroyer of which includes a pressurized fluid container of water and a carrier controlled delivery nozzle with an integral supply source of microbes which can be actuated by the carrier to spray high-pressure water containing microbes at dog poop accumulations.

### BACKGROUND OF THE INVENTION

1. Field of the Invention

The present invention relates to a method and apparatus for destroying dog poop. More particularly, it relates to a portable supply of pressurized water which can be carried by a dog walker, tourist, home owner, or sanitary engineer to spray on and break up dog poop.

Still more particularly, the present invention relates to a pressurized supply of portable water in the form of a pressure washer which can be injected with chemicals from an integrated portable supply which is in fluid delivery communication with the pressurized supply of water. Specifically, the present invention is a pressurized water container having a flexible nozzle with a trigger actuated cutoff and a supply of liquid microbes which are injected into the fluid discharge from said container which, upon being delivered in a fluid stream from the container, on contact with the dog poop commences to break it up and neutralize it.

2. Description of the Prior Art

The use of apparatus and methods in one form or another for the purpose of enhancing the environment by the elimination or removal of dog poop is known in the prior art. However, despite the numerous designs, structures, and forms of apparatus disclosed by and utilized in the prior art, which have been developed for the accomplishment of the specific objectives, purposes, and requirements of dog poop removal, elimination, and destruction or neutralization, the devices, machines, apparatus, and methods which have been heretofore devised and utilized to accomplish these goals consist basically of familiar, expected, and obvious configurations, combinations, and arrangements of well known apparatus. This will become apparent from the following consideration of the closest known and relevant prior art.

Some dog owners and dog poop removers simply carry a plastic bag in which they pick up the various accumulations. They then have to carry it with them until they can dispose of it in a proper receptacle. Some persons are embarrassed to be obviously carrying a deposit of poop in a bag until they reach a proper receptacle because they are reluctant to hide it in their pockets. Other persons feel inconvenienced to have to carry their dog's poop around and would prefer to dispense with the pleasure.

Some dog owners and dog poop removers carry various types of removal devices which fall in the general classification of pooper scoopers which pick up and carry the offending material for the operator to the deposition area. All of these devices operate on the basic principal that the dog deposits must be removed from the scene of the action and disposed of elsewhere. None of them render the poop inactive except by desiccation.

The dog poop destroyer apparatus and method contemplated according to the present invention departs substantially from the conventional concepts and designs taught and used by the prior art, and in doing so, provides an apparatus and method primarily developed for the purpose of overcoming the problems as described above, but it accomplishes the result in a different and improved manner for producing dog poop destruction more easily, conveniently, effectively, faster, economically, more environmentally friendly, and more completely.

### SUMMARY OF THE INVENTION

In view of the foregoing known, obvious, and described disadvantages inherent in the known types of dog poop removal presently existing in the prior art, the present invention provides a new method, apparatus, and construction for dog poop destruction and elimination wherein the same can be utilized to destroy dog poop wherever it lies.

The general purpose and construction of the present invention, which will be described hereafter in greater detail, has been designed to provide a new and improved dog poop elimination and destruction apparatus and method which has many of the advantages of the prior art of dog poop removal mentioned and described above but is easier and more aesthetically pleasing to operate and more environmentally friendly. It is comprised of many novel features and advantages and performs the functions that result in a new dog poop destroyer which is not anticipated, rendered obvious, suggested, or even implied by any of the prior art of dog poop removal method and apparatus and heretofore known, either alone or in any combination thereof.

The present invention is a dog poop destroyer comprised of a pressurized portable water container and a flexible nozzle in fluid delivery communication with the container. The nozzle has a trigger actuated shutoff valve formed integral thereto. A chemical container is provided for injecting chemicals such as microbes into the discharge from the nozzle when the nozzle is actuated. A fluid inlet adapter is provided for permitting pressurized water to fill the pressurized portable water container from the male end of a garden hose connection.

The more important features of the invention have been broadly outlined in the preceding summary of the invention in order that the detailed description thereof which follows may be better understood and in order that the present contribution to an improvement in the art may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a dog poop destroyer which is portable and can be carried by a dog walker or property owner during unexpected encounters with or production of dog droppings.

It is another object of the present invention to provide a portable dog poop destroyer which can spray water under pressure to breakup piles and chunks of dog poop accumulations.

It is a further object of the present invention to provide a dog poop destroyer which delivers a liquid stream of microbes to a dog poop pile.

It is still another object of the present invention to provide a pressurized and portable dog poop destroyer which can be easily filled with water from a common garden hose.

It is yet a further object of the present invention to provide a new and novel method and apparatus for dog poop destruction which is environmentally friendly.

And it is still a further object of the present invention to provide a new and novel portable pressure washer which can spray chemicals.

Other objects and advantages of the present invention will become apparent when the method and apparatus of the present invention are considered in conjunction with the accompanying drawings.

### DESCRIPTION OF THE DRAWINGS

FIG. 1 is a perspective view showing the dog poop destroyer apparatus assembled in operative condition;

FIG. 2 is a partial perspective view showing the dog poop destroyer water delivery system being filled by a common garden hose;

FIG. 3 is a partial perspective view showing the dog poop destroyer water delivery system filled with water with the microbe delivery container attached thereto and the garden hose detached therefrom;

FIG. 4 is a partial cross-section view of the one-way water inlet check-valve in the closed condition; and

FIG. 5 is a partial cross-section view showing the one-way water inlet check-valve with the garden hose attached and delivering water to the pressurized water container through the check valve.

### DESCRIPTION OF THE PREFERRED EMBODIMENT

Reference is made to the drawings for a description of the preferred embodiment of the present invention wherein like reference numbers represent like elements on corresponding views.

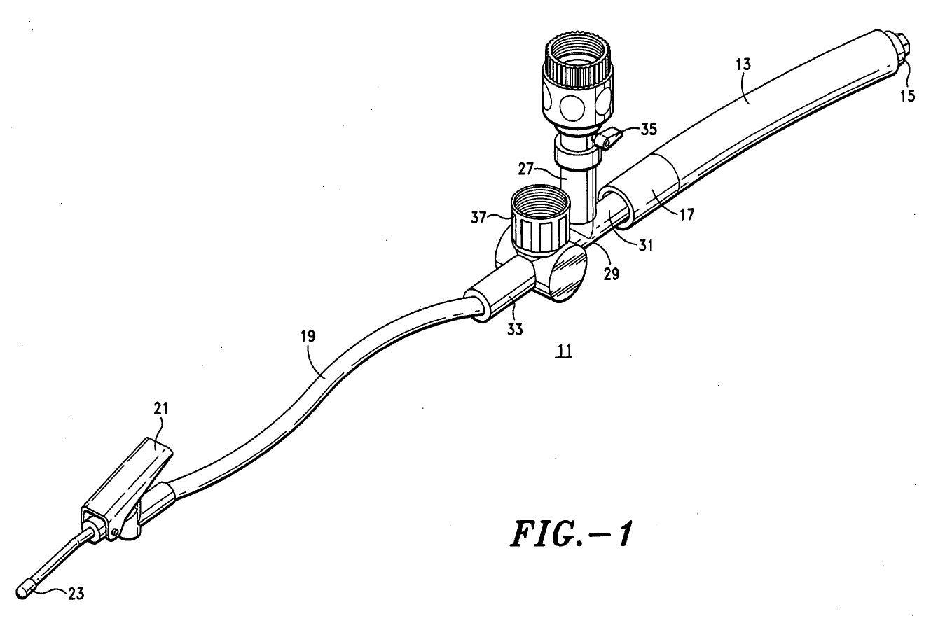

FIG. 1 is a perspective view of the assembled elements of the present invention which is a dog poop destroyer 11. The drawing shows the apparatus assembled in operative condition. The mechanical activator for the apparatus is a pressurized portable water container 13.

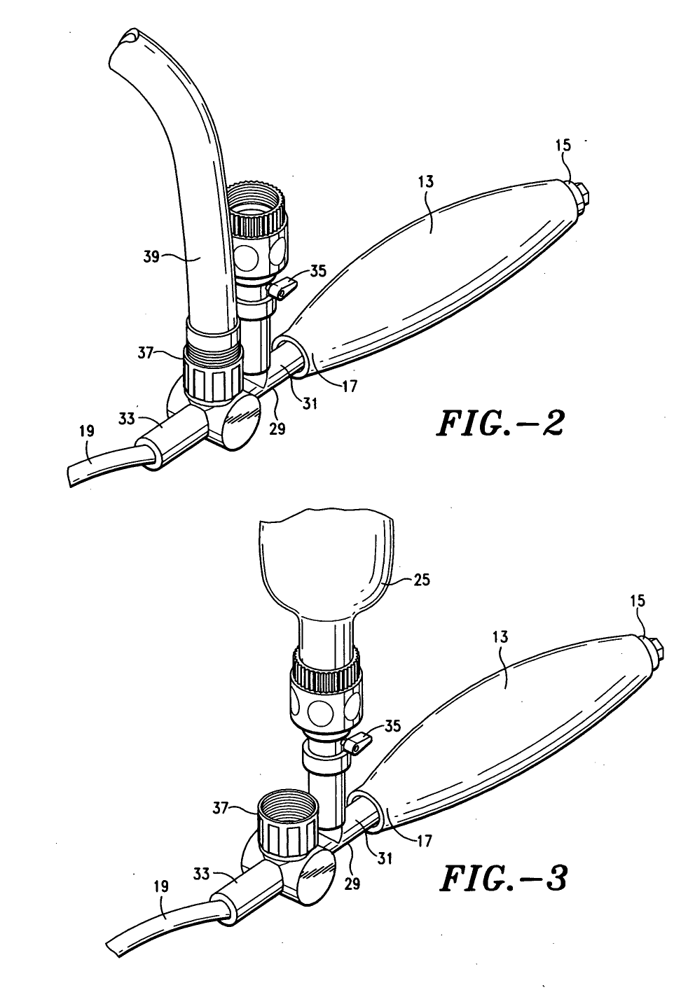

Reference is made to FIGS. 1-3. In the preferred embodiment of the invention, the pressurized portable water container is in the form of an expandable rubberized balloon. For convenient carry, the balloon is an elongated tube closed at one end 15 and securable to a nipple at the other end 17. The nipple permits the balloon to be connected to the operative mechanism of the apparatus which controls the selective discharge of pressurized water from the balloon. A covering such as a bag with a shoulder carrying strap can be utilized to encase the tube for convenient carry.

A flexible nozzle which is in fluid delivery communication with the pressurized portable water container 13 is provided for dispensing the pressurized fluid. A flexible hose 19 extends from the nipple to which the pressurized portable water container is attached. The hose has a trigger 21 actuated shutoff valve/nozzle 23 disposed at the free outlet end thereof formed integral thereto for controlling the discharge of water from the pressurized water container. The nozzle is spring-loaded closed whereby actuation of the squeeze handle trigger of the shutoff valve allows water from the pressurized container to flow from the nozzle whereby the effluent stream of water can be accurately directed by the destroyer carrier towards preferred targets on the ground or elsewhere.

A chemical container 25 is provided for containing a chemical supply for inclusion in the fluid discharge from the nozzle. The container is designed for containing soluable particulate or a solution of chemicals. In the preferred embodiment of the invention, it is secured proximate to the water discharge from the pressurized portable water container, although in theory it could be positioned anywhere in the apparatus connecting with the water stream before it exits the nozzle.

In the preferred embodiment of the invention, the chemicals are microbes, but any chemicals could be utilized such as insecticides, fertilizers, plant food, detergents, sanitizing mixtures, or any other chemicals which might be utilized in a pressure washer or fluid spray delivery system. The microbes for the preferred embodiment of the invention are most usually supplied in the marketplace in powder state. They can be supplied to the fluid stream of the present invention either in powder form or pre-activated by mixing them into a water solution.

The microbe container 25 is secured to the perpendicular inlet 27 of a T tube 29 with a first end 31 of the straight section of the T tube forming the nipple to which the pressurized water container is connected. The second end 33 of the straight section is interconnected in fluid communication to the flexible delivery hose 19. The container shown in the drawing is formed for containing a solution of microbes. Other possible forms of microbes, such as a soluble particulate, might be dispensed from other forms of containers specifically designed for that purpose but which can be adapted to a typical male-female or other type of interconnection permitting flow through communication with the fluid stream.

The chemical container 25 whatever its form has a connection with the pressurized fluid stream which is ejected from the pressurized portable water container 13 when the nozzle 23 is actuated. The chemical container can be provided with a shutoff valve 35 located between the microbe supply and the pressurized fluid stream discharging from the pressurized portable water container. Such a control is necessary for several reasons. Primarily, it prevents back flow intrusion of the container by water being inletted to the pressurized container during filling. Especially important, however, is the need to be able to selectively stop the flow of microbes into the water stream from the container when desired.

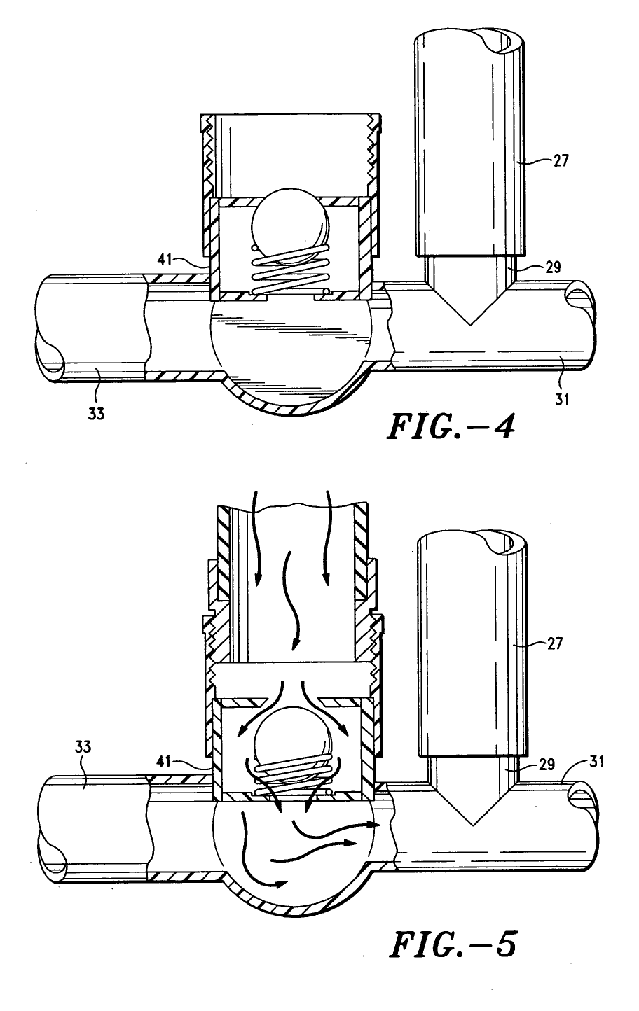

A pressurized fluid inlet adapter 37 is provided for permitting pressurized water to fill the portable container from the male end of a common garden hose 39 connection as shown in FIG. 5. The adapter includes a check valve 41 to prevent water from backflowing from the pressurized portable water container when a filling hose is disconnected therefrom as shown in FIG. 4.

The present invention also includes a method for dog poop accumulation destruction. The steps include providing a dog walker or poop destroyer carrier with a portable supply of self-contained pressurized water, a discharge stream from which can be directed by the portable supply carrier accurately to accumulations of dog poop. A control mechanism is provided to permit the water supply carrier to selectively actuate a discharge stream from the portable supply at the carrier's discretion. A separate supply of microbes is provided which is automatically injected into the discharge stream when the carrier actuates the control mechanism to create a water discharge from the portable supply. Dog poop accumulations are then destroyed by spraying them with pressurized water laced with microbes to breakup the dog poop and cover it with liquid microbes which will eat up the dog poop.

Thus, it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

1. A hand transportable dog poop destroyer comprising
a fluid conducting manifold
a pressurized portable water container in the form of an expandable balloon secured to and in fluid communication with said manifold,
a flexible discharge nozzle in fluid delivery communication with said manifold, said nozzle having a trigger actuated shutoff valve formed integral thereto, and
a fluid inlet adapter formed integral to said manifold for permitting pressurized water to fill said pressurized container from the male end of a garden hose connection, said fluid inlet adapter including a unidirectional flow check valve to prevent water from backflowing from said pressurized portable water container when a filling hose is disconnected from said manifold.

2. (canceled)

3. The dog poop destroyer of claim 1 wherein said flexible nozzle includes a hose extending from said manifold with a trigger controlled valve disposed at the outlet end thereof.

4. The dog poop destroyer of claim 9 wherein said chemical dispenser container for injecting chemicals into said water discharge is designed for containing a soluable particulate or a solution of microbes secured to said manifold between the discharge end of said pressurized portable water container and said nozzle whereby it has a chemical delivery interconnection with the pressurized fluid stream being ejected from said container when said nozzle is actuated.

5. The dog poop destroyer of claim 9 wherein said chemical dispenser container has a manual shutoff valve located between said chemical dispenser and said pressurized fluid stream discharging from said pressurized portable water container.

6. (canceled)

7. A hand transportable dog poop destroyer comprising
a fluid conducting manifold
a pressurized portable water container in the form of an expandable rubberized balloon secured to and in fluid communication with said manifold,
a flexible hose in fluid delivery communication with said manifold, said hose having a trigger actuated shutoff valve nozzle disposed at the free end thereof,
a chemical dispenser container interconnected to said manifold, said container formed for containing a microbe supply and having a microbe delivery interconnection with the fluid delivery stream in said manifold for injecting microbes into the water flow in said manifold when said nozzle is actuated by said trigger, said microbe chemical dispenser container having a shutoff valve located between said microbe supply and said pressurized fluid stream in said manifold, and
a fluid inlet adapter formed integral to said manifold for permitting pressurized water to fill said pressurized container from the male end of a garden hose connection, said adapter including a unidirectional flow check valve to prevent water from backflowing from said pressurized portable water container when a filling hose is disconnected therefrom.

8. (canceled)

9. The dog poop destroyer of claim 1 including
a chemical dispenser container interconnected to said manifold for injecting chemicals into the water discharge from said nozzle when said nozzle is actuated.
